(19) United States
(12) Patent Application Publication
(10) Pub. No.: US 2026/0170588 A1
(43) Pub. Date: Jun. 18, 2026

(54) IMAGE GENERATING METHOD, IMAGE REPRODUCING METHOD AND ELECTRONIC DEVICE USING THE SAME

(71) Applicant: Acer Incorporated, New Taipei City (TW)

(72) Inventors: Chi-Kang LEE, New Taipei City (TW); Shih-Hao LIN, New Taipei City (TW); Sergio Cantero Clares, New Taipei City (TW); Chieh-Sheng WANG, New Taipei City (TW)

(73) Assignee: Acer Incorporated, New Taipei City (TW)

(21) Appl. No.: 19/341,496

(22) Filed: Sep. 26, 2025

(30) Foreign Application Priority Data
Dec. 12, 2024 (TW) 113148505

(51) Int. Cl. G06T 1/00; G06T 11/00

(52) U.S. Cl. CPC G06T 1/0021; G06T 11/00; G06T 2201/0065

(57) ABSTRACT

An image generating method, an image reproducing method and an electronic device using the same are provided. The image generating method includes the following steps. A prompt, a stable diffusion seed and an out painting seed are obtained. A generated image is generated via an image generating model according to the prompt, the stable diffusion seed and the out painting seed. The prompt, the stable diffusion seed and the out painting seed are encoded into a hidden watermark. The hidden watermark is added to the generated image.

This application claims the benefit of Taiwan application Serial No. 113148505, filed December 12, 2024, the disclosure of which is incorporated by reference herein in its entirety.

### TECHNICAL FIELD

The present disclosure relates to an image processing method and an electronic device, and more particularly to an image generating method, an image reproducing method, and an electronic device using the same.

### BACKGROUND

AI drawing technology is developing rapidly and is frequently used in creative projects. However, when users encounter an AI image they like, they can only find similar images by taking a photo or screenshot, then searching for them using image search, but it's impossible to obtain an identical AI image. Therefore, how to enable users to obtain the same AI image has become a current research topic in the industry.

### SUMMARY

This disclosure relates to an image generating method, an image reproducing method, and an electronic device utilizing the same. By adding a hidden watermark to an image, the method embeds AI image generation parameters and information without affecting the image's aesthetics or quality, allowing users to quickly reproduce identical AI images.

According to one embodiment, an image generating method is provided. The image generating method includes: obtaining a prompt, a stable diffusion seed and an out painting seed; generating, via an image generating model, a generated image according to the prompt, the stable diffusion seed and the out painting seed; encoding the prompt, the stable diffusion seed, and the out painting seed into a hidden watermark; and adding the hidden watermark to the generated image.

According to another embodiment, an image reproducing method is provided. The image reproducing method includes: photographing or capturing, by an image capturing unit, a generated image to obtain a captured image, wherein the generated image has a hidden watermark; performing a decoding process for the hidden watermark in the captured image to obtain a prompt of an image generating model, a stable diffusion seed and an out painting seed; and generating, via an image generating model, a regenerated image according to the prompt, the stable diffusion seed and the out painting seed.

According to an alternative embodiment, an electronic device is provided. The electronic device includes an image capturing unit, a decoding unit and a computing unit. The image capturing unit is used for photographing or capturing a generated image to obtain a captured image. The generated image has a hidden watermark. The decoding unit is used for performing a decoding process for the hidden watermark in the captured image to obtain a prompt of an image generating model, a stable diffusion seed and an out painting seed. The computing unit is used for obtaining a regenerated image according to the prompt, the stable diffusion seed and the out painting seed.

### BRIEF DESCRIPTION OF THE DRAWINGS

FIG. 1 illustrates an image reproducing method according to one embodiment of the present disclosure.

FIG. 2 shows a block diagram of an electronic device for performing image generation according to an embodiment of the present disclosure.

FIG. 3 illustrates a block diagram of an electronic device for performing image reproduction according to an embodiment of the present disclosure.

FIG. 4 illustrates an image generating method and an image reproducing method according to an embodiment of the present disclosure.

FIG. 5 illustrates an image generating method and an image reproducing method according to another embodiment of the present disclosure.

FIG. 6 illustrates an image generating method and an image reproducing method according to another embodiment of the present disclosure.

FIG. 7 illustrates an image generating method and an image reproducing method according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

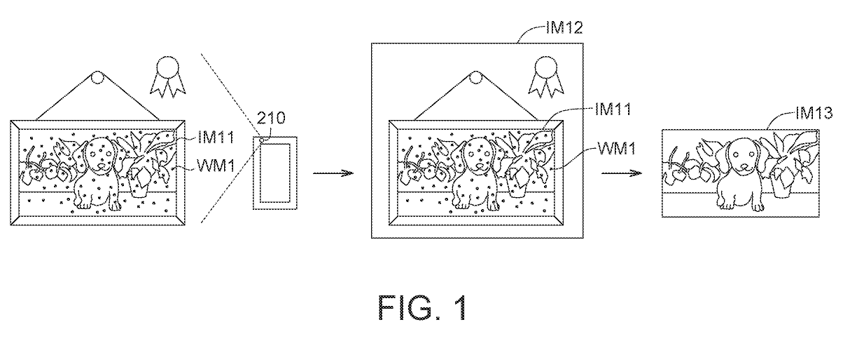

Please refer to FIG. 1, which illustrates an image reproducing method according to one embodiment of the present disclosure. In this embodiment, an AI model adds a hidden watermark WM1 containing AI model parameters during the generation of a generated image IM11. The hidden watermark WM1 is scattered across several pixels of the generated image IM11 and is imperceptible to the human eye. A user could use an image capturing unit 210 to capture a captured image IM12. For example, the user will capture the frame, the wall, the generated image IM11, and the added hidden watermark WM1.

Next, we could obtain the hidden watermark WM1 from the captured image IM12. After decoding the hidden watermark WM1, we could obtain the parameters of the AI model and obtain a regenerated image IM13 that is identical to the generated image IM11.

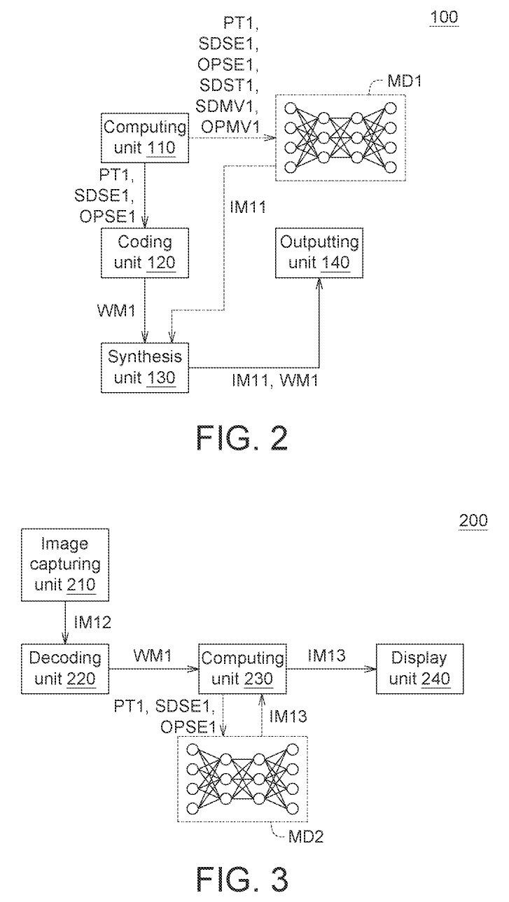

Please refer to FIG. 2, which shows a block diagram of an electronic device 100 for performing image generation according to an embodiment of the present disclosure. The electronic device 100 is, for example, a notebook computer, a desktop computer, a mobile phone, a server, or a cloud computing center. The electronic device 100 includes a computing unit 110, a coding unit 120, a synthesis unit 130, and an outputting unit 140.

The computing unit 110, the coding unit 120, and the synthesis unit 130 are used to perform various calculations, encoding, and processing, such as a circuit, a circuit board, a storage device storing program code, or a chip. The outputting unit 140 is used to output various information, such as to a display, a transmission module, or a printer.

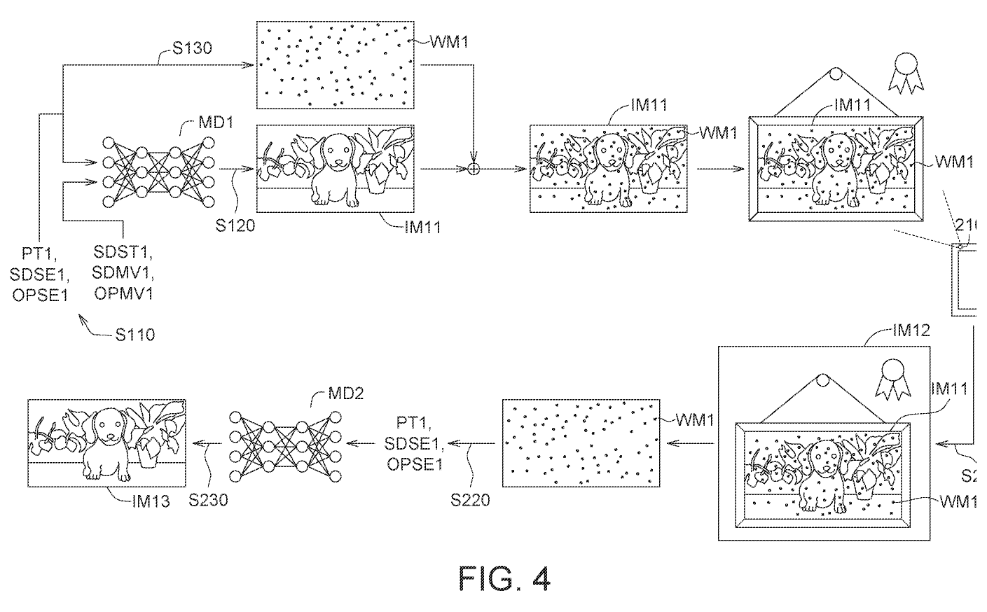

Please refer to FIG. 3, which illustrates a block diagram of an electronic device 200 for performing image reproduction according to an embodiment of the present disclosure. The electronic device 200 includes the image capturing unit 210, a decoding unit 220, a computing unit 230, and a display unit 240. The image capturing unit 210 is used to capture images and could be implemented as a camera, a webcam, a monitor, or a video recorder with photo or video recording capabilities, or as a mouse or a keyboard capable of capturing screenshots.

The decoding unit 220 and the computing unit 230 are used to perform various decoding and calculation processes, such as a circuit, a circuit board, a storage device storing program code, or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof. The display unit 240 is used to display information, for example, a liquid crystal display panel, an electronic paper display panel or an OLED display panel.

In this embodiment, the electronic device 100 uses AI generation technology to generate the generated image IM11 and then adds the hidden watermark WM1. After the user obtains the captured image IM12 by photographing or taking a screenshot, the electronic device 200 decodes the hidden watermark WM1 to obtain the regenerated image IM13 that is identical to the generated image IM11. The following flowchart details the operation of each component.

Please refer to FIG. 4, which illustrates an image generating method and an image reproducing method according to an embodiment of the present disclosure. The image generating method and the image reproducing method include steps S110 to S140 and steps S210 to S230.

In the step S110, as shown in FIG. 2 and FIG. 4, the computing unit 110 of the electronic device 100 obtains a prompt PT1, a stable diffusion seed SDSE1, an out-painting seed OPSE1, a stable diffusion step SDST1, a stable diffusion model version SDMV1, and an out-painting model version OPMV1.

Next, in the step S120, as shown in FIGS. 2 and 4, an image generating model MD1 of the electronic device 100 obtains the generated image IM11 according to the prompt PT1, the stable diffusion seed SDSE1, the out-painting seed OPSE1, the stable diffusion step SDST1, the stable diffusion model version SDMV1, and the extended model version OPMV1. The generated image IM11 may be an image of a person, animal, or object.

Then, in the step S130, as shown in FIGS. 2 and 4, the coding unit 120 of the electronic device 100 encodes the prompt PT1, the stable diffusion seed SDSE1, and the out painting seed OPSE1 into the hidden watermark WM1.

In this step, the coding unit 120 could also encode the prompt PT1, the stable diffusion seed SDSE1, the out painting seed OPSE1, the stable diffusion step SDST1, the stable diffusion model version SDMV1, and the extended model version OPMV1 into the hidden watermark WM1.

Next, in the step S140, as shown in FIGS. 2 and 4, the synthesis unit 130 of the electronic device 100 adds the hidden watermark WM1 to the generated image IM11. For example, the hidden watermark WM1 is added in the entire area of the generated image IM11. The generated image IM11 could be displayed on a tablet, a LCD screen, a computer monitor, or a printed for presentation. Although the hidden watermark WM1 has been added to the generated image IM11, it is invisible to the naked eye. The steps S110 to S140 complete the image generating method. Next, if the generated image IM11 is to be reproduced, the process proceeds to the steps S210 to S230.

In the step S210, as shown in FIGS. 3 and 4, the image capturing unit 210 of the electronic device 200 photographs or captures the generated image IM11 to obtain the captured image IM12. In the step S210 of FIG. 4, the image capturing unit 210 of the electronic device 200 photographs the generated image IM11 to obtain the captured image IM12. Since the generated image IM11 has the hidden watermark WM1, the captured image IM12 also has the hidden watermark WM1.

Next, in the step S220, as shown in FIGS. 3 and 4, the decoding unit 220 of the electronic device 200 performs a decoding process for the hidden watermark WM1 in the captured image IM12 to obtain the prompt PT1 of an image generating model MD2, the stable diffusion seed SDSE1, and the out painting seed OPSE1.

Then, in the step S230, referring to FIGS. 3 and 4, the computing unit 230 of the electronic device 200 generates the regenerated image IM13 via the image generating model MD2 according to the prompt PT1, the stable diffusion seed SDSE1, and the out-painting seed OPSE1. In this step, the unchanged prompt PT1, the stable diffusion seed SDSE1, and the out painting seed OPSE1 are input into the image generating model MD2 to produce the regenerated image IM13 that is identical to the generated image IM11. The regenerated image IM13 does not contain the hidden watermark WM1. In one embodiment, the image generating model MD1 and the image generating model MD2 could be pre-defined to use the same stable diffusion step SDST1, the same stable diffusion model version SDMV1, and the same extended model version OPMV1, eliminating the need to obtain the stable diffusion step SDST1 and the stable diffusion model version SDMV1 through the hidden watermark WM1.

In the above embodiment, since the hidden watermark WM1 is first added to the generated image IM11 in the electronic device 100, when the user captures the generated image IM11, the generated image IM11 could be decoded on the electronic device 200 to obtain the regenerated image IM13 that is identical to the generated image IM11 and fully reproduced on the display unit 240.

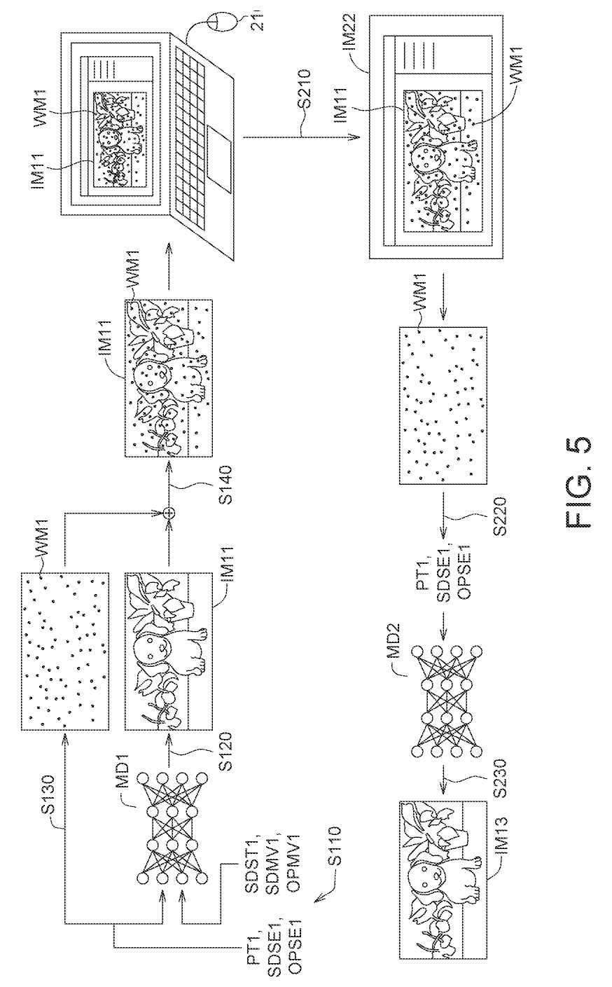

Please refer to FIG. 5, which illustrates an image generating method and an image reproducing method according to another embodiment of the present disclosure. In the step S210 of FIG. 5, the image capturing unit 210 of the electronic device 200 captures the generated image IM11 to obtain a captured image IM22. The image capturing unit 210 is, for example, a mouse, which uses a cursor to select a portion of the image for the capture.

Referring to FIG. 5, this embodiment differs from the previous embodiment in that, in the step S210, when the generated image IM11 is displayed on the screen of the electronic device 200, the image capturing unit 210 (e.g., a mouse) could be used to select a desired area for capture, thereby obtaining the captured image IM22. Since the generated image IM11 has the hidden watermark WM1, the captured image IM22 also has the hidden watermark WM1.

Next, in the step S220, as shown in FIGS. 3 and 5, the decoding unit 220 of the electronic device 200 decodes the hidden watermark WM1 on the captured image IM22 to obtain the prompt PT1 of the image generating model MD2, the stable diffusion seed SDSE1, and the out painting seed OPSE1.

Next, in the step S230, referring to FIGS. 3 and 5, the computing unit 230 of the electronic device 200 generates the regenerated image IM13 via the image generating model MD2 according to the prompt PT1, the stable diffusion seed SDSE1, and the out-painting seed OPSE1. In this step, the unchanged prompt PT1, the unchanged stable diffusion seed SDSE1, and the unchanged out-painting seed OPSE1 are input into the image generating model MD2 to generate the regenerated image IM13 identical to the generated image IM11. The regenerated image IM13 does not include the hidden watermark WM1. In one embodiment, the image generating models MD1 and MD2 could be pre-defined to use the same stable diffusion step SDST1, the same stable diffusion model version SDMV1, and the same extended model version OPMV1, eliminating the need to obtain the stable diffusion step SDST1 and the stable diffusion model version SDMV1 through the hidden watermark WM1.

In the above embodiment, since the hidden watermark WM1 is first added to the generated image IM11 in the electronic device 100, when the user takes a screenshot of the generated image IM11, the generated image IM11 could be decoded on the electronic device 200 to obtain the regenerated image IM13 that is identical to the generated image IM11 and fully reproduced on the display unit 240.

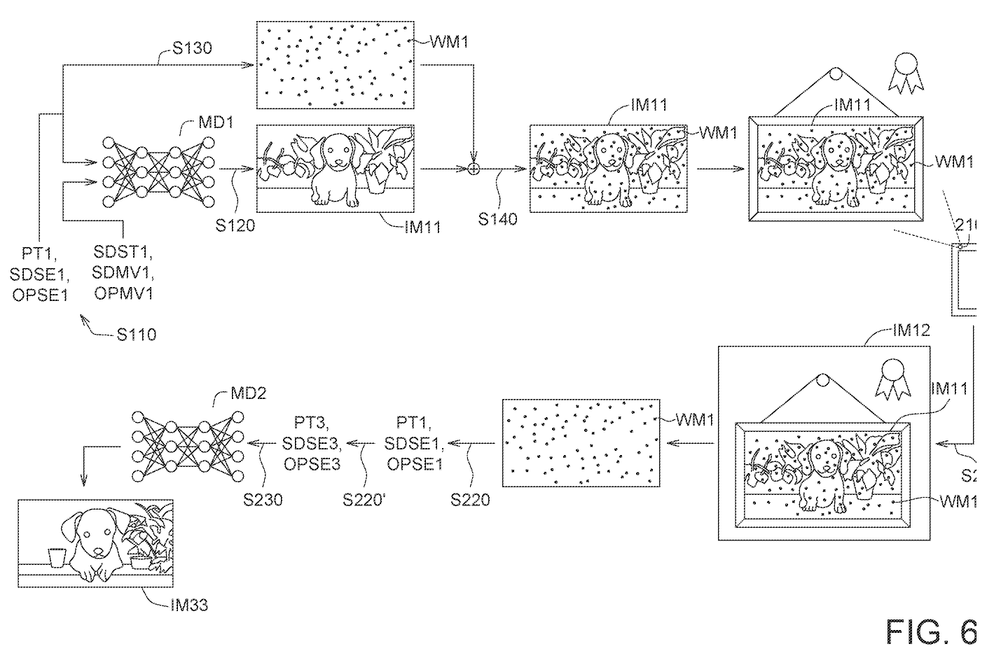

Please refer to FIG. 6, which illustrates an image generating method and an image reproducing method according to another embodiment of the present disclosure. In the step S220 of FIG. 6, the decoding unit 220 of the electronic device 200 decodes the hidden watermark WM1 in the captured image IM22 to obtain the prompt PT1 of the image generating model MD2, the stable diffusion seed SDSE1, and the out-painting seed OPSE1.

Then, in the step S220, as shown in FIG. 6, the prompt PT1, the stable diffusion seed SDSE1, and the out painting seed OPSE1 are changed to a prompt PT3, a stable diffusion seed SDSE3, and an out painting seed OPSE3, depending on the user's needs. For example, the user could change the background pattern, foreground object, color, style, and so on.

Next, in the step S230, as shown in FIG. 6, the computing unit 230 of the electronic device 200 generates a regenerated image IM33 via the image generating model MD2 according to the prompt PT3, the stable diffusion seed SDSE3, and the out-painting seed OPSE3. In this step, the modified prompt PT3, the modified stable diffusion seed SDSE3, and the modified out-painting seed OPSE3 are input into the image generating model MD2 to generate the regenerated image IM33 which is similar to the generated image IM11. The regenerated image IM33 does not contain the hidden watermark WM1.

In the above embodiment, since the hidden watermark WM1 is first added to the generated image IM11 in the electronic device 100, after the user takes a photo or screenshot of the generated image IM11, the generated image could be decoded and its parameters modified in the electronic device 200. Finally, the regenerated image IM33 similar to the generated image IM11 is obtained and fully reproduced on the display unit 240.

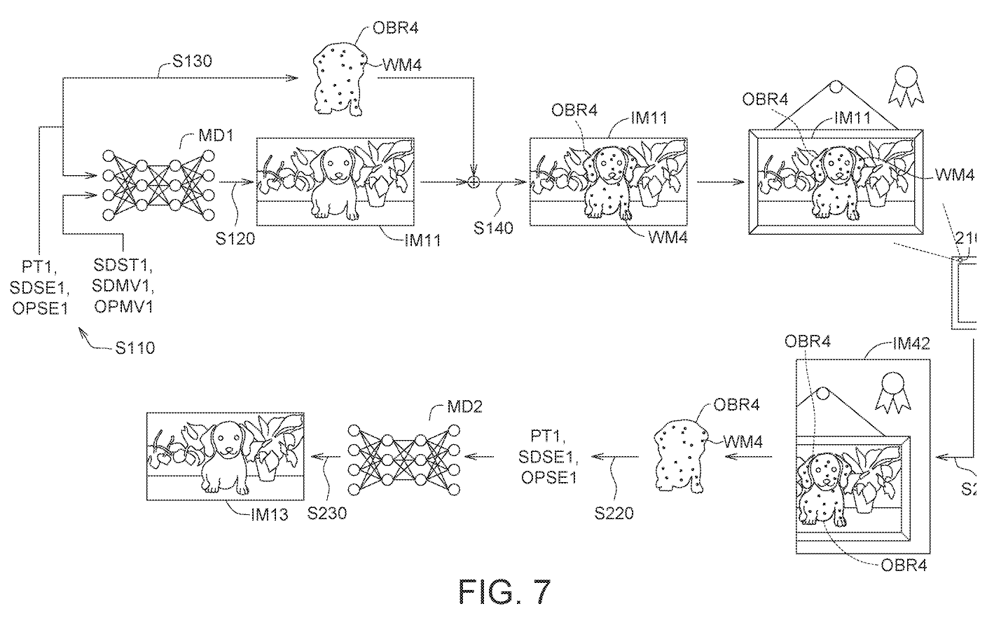

Please refer to FIG. 7, which illustrates an image generating method and an image reproducing method according to another embodiment of the present disclosure. In the step S130 of FIG. 7, the coding unit 120 of the electronic device 100 encodes the prompt PT1, the stable diffusion seed SDSE1, and the out painting seed OPSE1 into a hidden watermark WM4. In this step, the hidden watermark WM4 is set in a portion or center of the object range (e.g., an object range OBR4).

In this step, the coding unit 120 could also encode the prompt PT1, the stable diffusion seed SDSE1, the out painting seed OPSE1, the stable diffusion step SDST1, the stable diffusion model version SDMV1, and the extended model version OPMV1 as the hidden watermark WM4.

Next, in the step S140, as shown in FIGS. 2 and 7, the synthesis unit 130 of the electronic device 100 adds the hidden watermark WM4 to the generated image IM11. The hidden watermark WM4 is, for example, added in the object range OBR4 of the generated image IM11. The generated image IM11 could be displayed on a tablet, LCD screen, computer monitor, or printed for presentation. Although the hidden watermark WM4 has been added to the generated image IM11, it is invisible to the naked eye. The steps S110 to S140 complete the image generating method. Next, if the generated image IM11 is to be reproduced, the steps S210 to S230 are executed.

In the step S210, as shown in FIGS. 3 and 7, the image capturing unit 210 of the electronic device 200 photographs or captures the generated image IM11 to obtain a captured image IM42. In the step S210 of FIG. 7, the image capturing unit 210 of the electronic device 200 photographs the generated image IM11 to obtain the captured image IM42. As shown in FIG. 7, although the image capturing unit 210 only captures a portion of the generated image IM11, as long as the captured image IM42 covers the object range OBR4, the complete hidden watermark WM4 could be obtained in the captured image IM42.

Next, in the step S220, as shown in FIG. 3 and FIG. 7, the decoding unit 220 of the electronic device 200 performs a decoding process for the hidden watermark WM4 in the captured image IM42 to obtain the prompt PT1 of the image generating model MD2, the stable diffusion seed SDSE1 and the out painting seed OPSE1.

Next, in the step S230, referring to FIGS. 3 and 7, the computing unit 230 of the electronic device 200 generates the regenerated image IM13 via the image generating model MD2 according to the prompt PT1, the stable diffusion seed SDSE1, and the out-painting seed OPSE1. In this step, for example, the unchanged prompt PT1, the stable diffusion seed SDSE1, and the out-painting seed OPSE1 are input into the image generating model MD2 to generate the regenerated image IM13 identical to the generated image IM11. The regenerated image IM13 does not include the hidden watermark WM1. In one embodiment, the image generating models MD1 and MD2 could be pre-defined to use the same stable diffusion step SDST1, the same stable diffusion model version SDMV1, and the same extended model version OPMV1, eliminating the need to obtain the stable diffusion step SDST1 and the stable diffusion model version SDMV1 through the hidden watermark WM1.

According to the embodiment of FIG. 7, the hidden watermark WM4 is added only to a portion or the center of generated image IM11 (e.g., the object range OBR4). Even if the user captures an incomplete image, the hidden watermark WM4 could still be successfully decoded to obtain the regenerated image IM13 that is identical to the generated image IM11 and fully reproduced on the display unit 240.

Through the various embodiments described above, the electronic device 100 could generate the generated image IM11 using AI generation technology and then add the hidden watermarks WM1 and WM4. After obtaining the captured images IM12, IM22, and IM42 through photography or screenshots, the electronic device 200 could decode the hidden watermarks WM1 and WM4, allowing the user to obtain the regenerated image IM13 identical to the generated image IM11 or the regenerated image IM33 similar to the generated image IM11.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An image generating method, comprising:
obtaining a prompt, a stable diffusion seed and an out painting seed;
generating, via an image generating model, a generated image according to the prompt, the stable diffusion seed and the out painting seed;
encoding the prompt, the stable diffusion seed, and the out painting seed into a hidden watermark; and
adding the hidden watermark to the generated image.

2. The image generating method according to claim 1, wherein the hidden watermark is added in an entire range of the generated image.

3. The image generating method according to claim 1, wherein the hidden watermark is added in a part of the generated image.

4. The image generating method according to claim 1, wherein the hidden watermark is added in a center of the generated image.

5. The image generating method according to claim 1, wherein the hidden watermark is added in an object range of the generated image.

6. An image reproducing method, comprising:
photographing or capturing, by an image capturing unit, a generated image to obtain a captured image, wherein the generated image has a hidden watermark;
performing a decoding process for the hidden watermark in the captured image to obtain a prompt of an image generating model, a stable diffusion seed and an out painting seed; and
generating, via an image generating model, a regenerated image according to the prompt, the stable diffusion seed and the out painting seed.

7. The image reproducing method according to claim 6, wherein the hidden watermark is added in an entire range of the generated image.

8. The image reproducing method according to claim 6, wherein the hidden watermark is added in a part of the generated image.

9. The image reproducing method according to claim 6, wherein the hidden watermark is added in a center of the generated image.

10. The image reproducing method according to claim 6, wherein the hidden watermark is added in an object range of the generated image.

11. The image reproducing method according to claim 6, further comprising:
changing the prompt, the stable diffusion seed or the out painting seed according to a need from a user.

12. The image reproducing method according to claim 6, wherein the captured image is part of the generated image.

13. An electronic device, comprising:
an image capturing unit, used for photographing or capturing a generated image to obtain a captured image, wherein the generated image has a hidden watermark;
a decoding unit, used for performing a decoding process for the hidden watermark in the captured image to obtain a prompt of an image generating model, a stable diffusion seed and an out painting seed; and
a computing unit, used for obtaining a regenerated image according to the prompt, the stable diffusion seed and the out painting seed.

14. The electronic device according to claim 13, wherein the hidden watermark is added in an entire range of the generated image.

15. The electronic device according to claim 13, wherein the hidden watermark is added in a part of the generated image.

16. The electronic device according to claim 13, wherein the hidden watermark is added in a center of the generated image.

17. The electronic device according to claim 13, wherein the hidden watermark is added in an object range of the generated image.

18. The electronic device according to claim 13, wherein the prompt, the stable diffusion seed or the out painting seed is changed according to a need from a user.

19. The electronic device according to claim 13, wherein the captured image is part of the generated image.

20. The electronic device according to claim 13, wherein the image capturing unit is a camera, a webcam, a monitor, a video recorder, a mouse or a keyboard.
